(19) United States
(12) Patent Application Publication
(10) Pub. No.: US 2005/0183866 A1
(43) Pub. Date: Aug. 25, 2005

(54) Apparatus and method for transporting a transport medium

(76) Inventor: Patrick Gilson, Poway, CA (US)

Correspondence Address: ALBERT HARNOIS, 14317 GAELYN COURT, POWAY, CA, 92064, US

(21) Appl. No.: 11/022,529

(22) Filed: Dec. 22, 2004

Related U.S. Application Data
(60) Provisional application No. 60/531,146, filed on Dec. 22, 2003.

(51) Int. Cl. A62C 35/00

(52) U.S. Cl. 169/16; 239/549

(57) ABSTRACT

A transport system of piping/tubing with substantially circular holes substantially equally spaced from each other can be used as a fire protection system or for other purposes requiring the transport of a transport medium, which is sprayed.

### CLAIM OF PRIORITY UNDER 35 U.S.C. §119

The present Application for Patent claims priority to Provisional Application No. 60/531,146 entitled “Water Sprinkler Fire Protection System” filed Dec. 22, 2004, and hereby expressly incorporated by reference herein.

### FIELD

The present disclosed embodiments relates generally to transport a transport medium, and more specifically to applying a transport medium to a surface.

### BACKGROUND

Transport systems include nozzles, spraying nozzles, water jets, or sprinkler heads. These parts add cost to the transport system and can break. Transport systems are often pressurized and are likely to freeze in sub-zero centigrade temperatures, thereby rendering them useless. There is therefore a need in the art for a transport system that is not pressurized and does not include parts such as nozzles, spraying nozzles, waterjets, or sprinklers.

### SUMMARY

In an aspect, a transport system comprises a tubing with substantially equally spaced holes operable to transport a transport medium, and a supply of a transport medium.

In another aspect, a tubing comprises holes substantially equally spaced from each other, the tubing operable to transport a transport medium. The holes are substantially circular.

Various aspects and embodiments of the invention are described in further detail below.

### BRIEF DESCRIPTION OF THE DRAWINGS

FIG. 1 is a perspective view of an exterior fire protection system in accordance with an embodiment;

FIG. 2 is a perspective view of an exterior fire protection system with other components that can be added to the system in accordance with an embodiment;

FIG. 3 is a perspective view of an exterior fire protection system and how the piping is attached to the structure;

FIG. 4 is a perspective view of an exterior fire protection system with containers couple into a manifold;

FIG. 5A shows a magnified view of the piping/tubing in accordance with an embodiment;

FIG. 5B illustrates various angles (0-120 degrees) that the plurality of holes can have with respect to the face of a structure in accordance with an embodiment;

FIG. 5C shows piping with arrows indicating the area where various tubing types are hung in accordance with an embodiment;

FIG. 6 shows a perspective view of how a liquid/gaseous solution can be isolated within the piping system when applied to a residence in accordance with an embodiment;

FIG. 7 is a perspective view of how the system can communicate both electrically/electronically with individual components in accordance with an embodiment;

FIG. 8 is a perspective view of the system that is coupled to a supply such as a residence pool, well, stream, river, lake, or swamp in accordance with an embodiment; and

FIG. 9 shows an electromechanical schematic of the system in accordance with an embodiment.

### DETAILED DESCRIPTION

A transport medium is a medium that can be transported, i.e., moved. Transport mediums include liquid, gas, and light.

In an embodiment, a protection system such as a fire protection system includes a piping system mounted to a structure and having a plurality of holes for spraying a transport medium such as water or a chemical fire retardant solution.

In an embodiment, a fire protection system includes strategically placed plurality of detectors such as heat or smoke detectors mounted to a structure's eaves or fascia/sofit and electrically coupled to a control panel, such as a fire alarm panel. In an embodiment, the detectors are mounted to the underside of a structure's eaves or fascia/sofit. Alternatively, the detectors are mounted to the outside of a structure's eaves or fascia/sofit. It would be apparent to those skilled in the art that detectors are not limited heat or smoke, but may also include for example infra-red detectors. Any detector known in the art may be used in the fire protection system.

In an embodiment, a protection system includes automatic valves strategically placed in the piping system. For example, in a fire protection system, upon detection of fire the control panel relays a signal to an automatic valve which is coupled to a transport medium supply such as a water supply. The automatic valve opens, thereby allowing water to be delivered into the piping system at the automatic valve.

In an embodiment, piping for a fire protection system for a residence includes a plurality of sizes from ½ inch to two inches. It would be apparent to those skilled in the art that for large industrial buildings, piping would be larger and depends on the surface area to be protected.

In an embodiment, the piping is constructed of rust-resistant materials, which may include copper, Polybutylene (pb), Polyvinyl Chloride (pvc), Chlorinated Polyvinyl Chloride (cpvc), Acrylonitrile Butadien Styrene (abs), aluminum, stainless steel, or galvanized piping.

In an embodiment, a piping system includes a pressure switch for the case when the pressure of the supplied transport medium is insufficient for the piping system's intended purpose.

In an embodiment dealing with a fire protection system, should the supplied transport medium pressure be insufficient given the piping system's intended purpose, a pressure switch downstream of an automatic shutoff valve (asov) shuts off the asov and the pressure switch sends a run signal to a motor that is attached to a chemical fire retarding solution, for example. Responsive to the run signal, the motor pumps the chemical retarding solution into the piping system.

A chemical fire retarding solution tank becomes pressurized/siphoned due to the motor turning on and delivering the fire retardant solution through a series of plumbing tubes and fittings, then through a check valve and into the piping system in accordance with an embodiment. The piping system may be mounted on or in the vicinity of eaves for example.

The piping of the piping system has holes that are substantially circular. The circular shape means that the transport medium flows out of the holes with substantially equal pressure around the hole. In contrast, a transport medium would flow out of slots with disparate pressure from different parts of a slot. Thus, the holes spray from the holes in a substantially uniform fashion as opposed to the slots spraying from the slots disparately, i.e., unevenly, from the slots.

In a fire protection system, the fire retardant or water is sprayed upon the surface of a structure wall, thereby coating the exterior wall with a liquid solution and helping keep the surface moist.

In an embodiment, a transfer switch is attached to a structure's electrical circuitry such as a house's main electrical junction box, allowing power from a generator to be used. The generator power not only can be used to increase transport medium pressure by pumping more of a transport medium into the piping system, but also to drive emergency function such as emergency lighting. The transfer switch is switched on when the main electrical power is lost or reduced.

In an embodiment, soffit ventilation/vents are coated with an in tumescent chemical so as the temperature increases, a vent grid closes preventing any sparks, flame, or fire getting into an attic space/upper portion of a structure, or any open spaces of the structure where vents are found.

In an embodiment, a piping system is integrated with a pool system, whereby the transport medium is taken from a pool. In another embodiment, the piping system is linked to a pond, stream, river, or any man-made or natural water source and the transport medium is taken there from.

If a structure's water supply is insufficient, a pump is utilized to create needed suction or pressure required to fill the piping system with a transport medium. In an embodiment wherein the piping system is integrated with a pool system, a pool sump (submersible pump) is utilized to supply the needed suction or pressure required to fill the piping system with water from a pool in the first instance, and if the pool water is not in sufficient quantity, then the pool sump is utilized to fill the piping system with a transport medium from another transport medium supply.

A manifold can be inserted in-line with the system to allow the sprinkler system to be utilized for other purposes like: wall preservation, plant feeding solution, termite, ant, roach chemicals. Manual shutoff valves can be strategically placed within the piping system if the individual wants to isolate any of the sprays. This type system can also apply to petrol station's overhead. Applying this type of system can help subdue catastrophic fire and explosions.

In an embodiment, a manifold is inserted in-line with the piping system to allow the piping system to be utilized for purposes other than fire protection. For example, other purposes may include wall preservation, plant fertilizing and feeding, or the delivery of pesticides targeting termites, ants, or roaches. It would be apparent to those skilled in the art that a wide variety of transport mediums may be used in the piping system such that the piping system delivers the transport mediums to a surface area.

In an embodiment, manual shutoff valves are strategically placed within the piping system to isolate any set of holes on the pipes of the piping system.

In an embodiment, a piping system is applied to a petrol station. In an embodiment, the piping system is placed over petrol station and is set off by detectors that detect too much petrol in the air. For example, if the concentration of airborne petrol exceeds a certain threshold, then the piping system delivers a fire retardant solution, thereby preventing a dangerous situation. Thus, such a system can help prevent and subdue catastrophic fire and explosions.

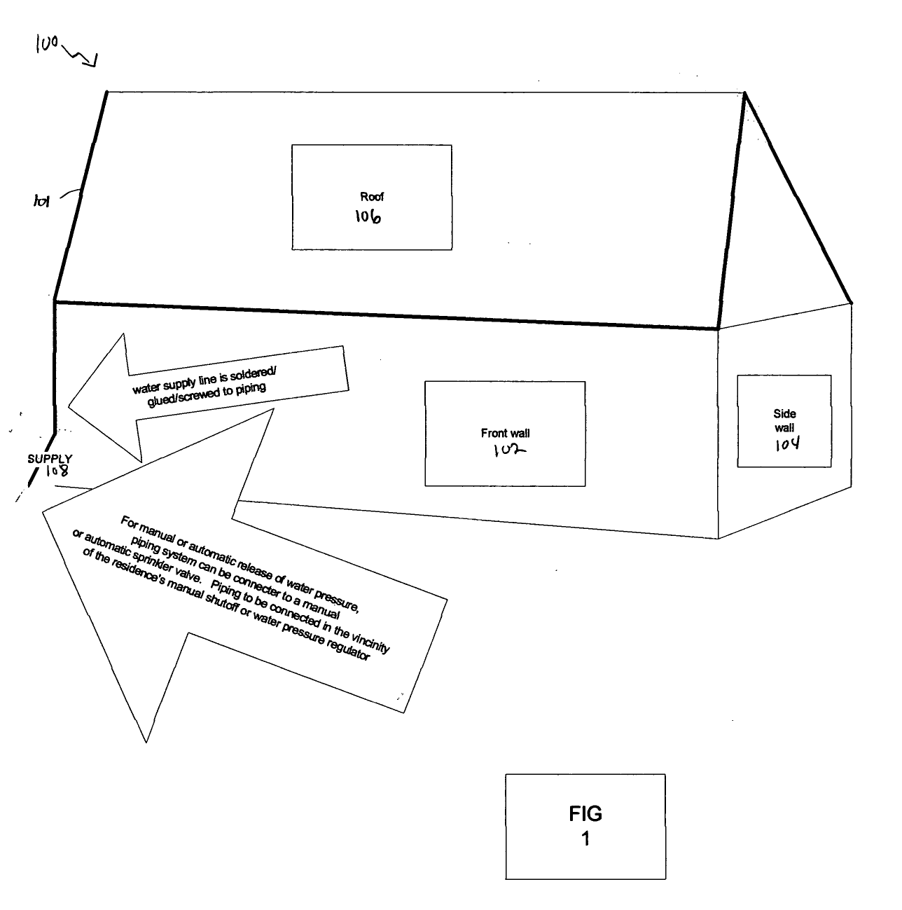

FIG. 1 is a perspective view of an exterior fire protection system 100 in accordance with an embodiment. FIG. 1 illustrates a typical installation and where the piping/tubing 101 is attached to a structure needing protection. The thick line represents tubing/piping run. FIG. 1 shows the front wall 102, side wall 104, and roof 106 of a structure.

The piping/tubing 101 is coupled to a supply 108 such as a residence water supply. For example, a water supply line can be soldered, glued, or screwed to the piping/tubing 101.

In an embodiment, the piping/tubing 101 can be coupled to a manual or automatic shut-off valve (ASOV) for manual or automatic release of water pressure.

The piping/tubing 101 is to be coupled in the vicinity of the residence's manual shutoff or water pressure regulator.

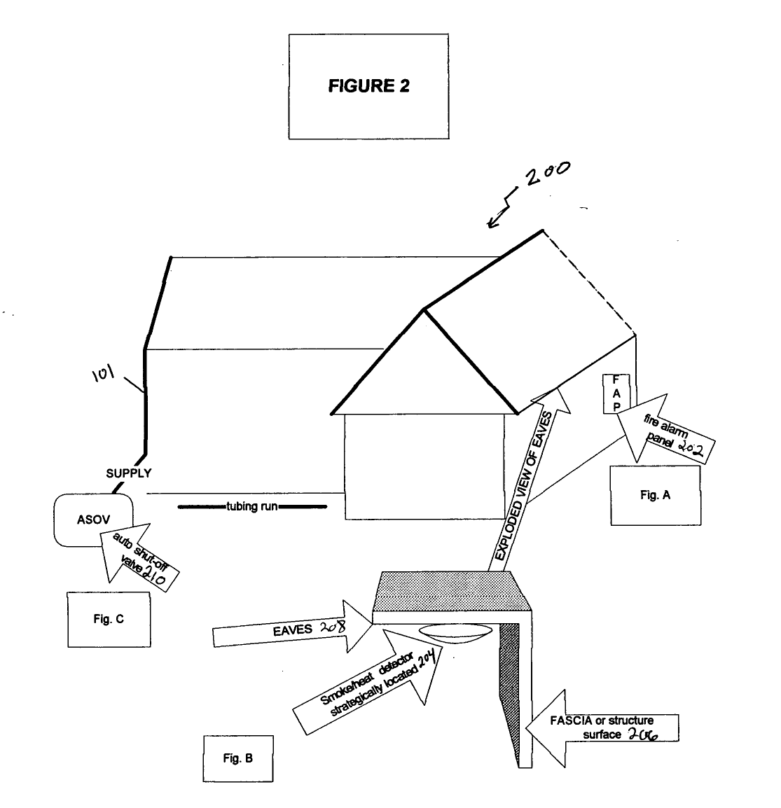

FIG. 2 is a perspective view of FIG. 1 with other components that can be added to the system in accordance with an embodiment. FIG. 2A shows a fire alarm panel (FAP) 202 that can be attached to the residence structure and be capable of communicating with a smoke/heat detector (SD) 204.

As shown in FIG. 2B, the SD 204 is strategically located on a fascia or structure surface 206. FIG. 2B illustrates an exploded view of the eaves 208 on the structure 200. The smoke/heat detector 204 can in turn communicate with a singular or plurality of automatic shutoff valve/s. An ASOV 210 is shown in FIG. 2C allowing a liquid/gaseous solution to flow through the system's piping 101 and to be sprayed onto the surface of the structure.

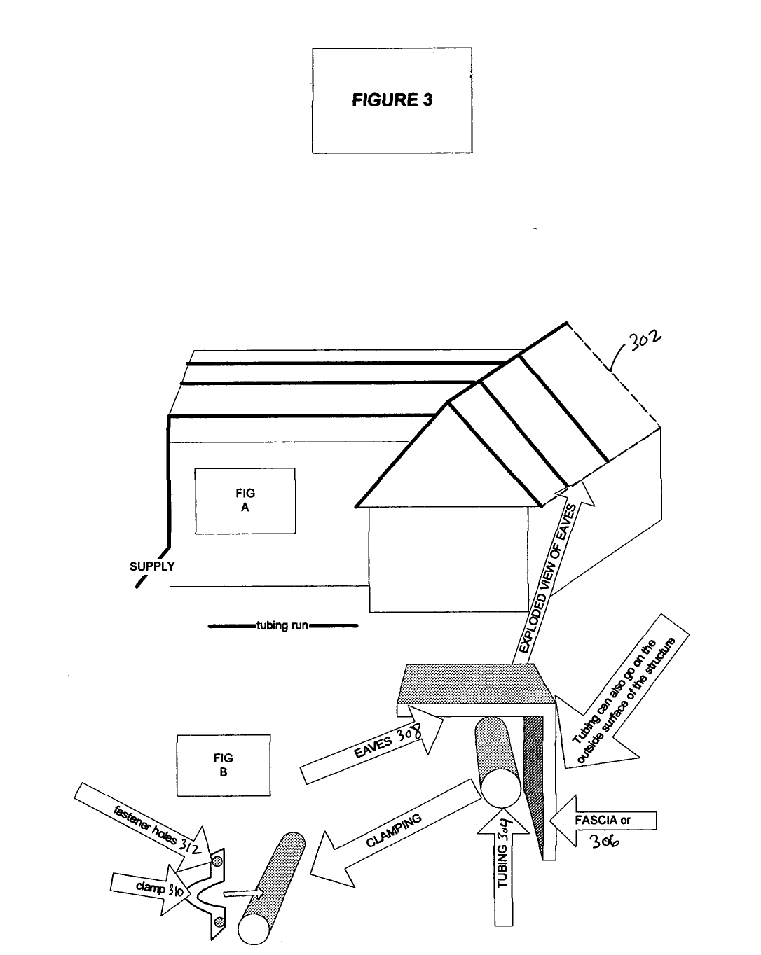

FIG. 3 is a perspective view of FIG. 2 and how the piping is attached to the structure as shown in FIG. 3B in accordance with an embodiment. FIG. 3A illustrates how the piping system can also be applied to the roof structure 302 in accordance with an embodiment. FIG. 3B show an exploded view of the eaves 308. Tubing 304 can also be coupled to the outside surface of the structure. The tubing 304 is located on a fascia or structure surface 306. A clamp 310 can be used to hold the tubing 304 in place. A fastener is placed through the fastener holes 312 to hold the tubing 304 in place. It would be apparent to those skilled in the art that the fastener can be any fastener known in the art like for example, a screw.

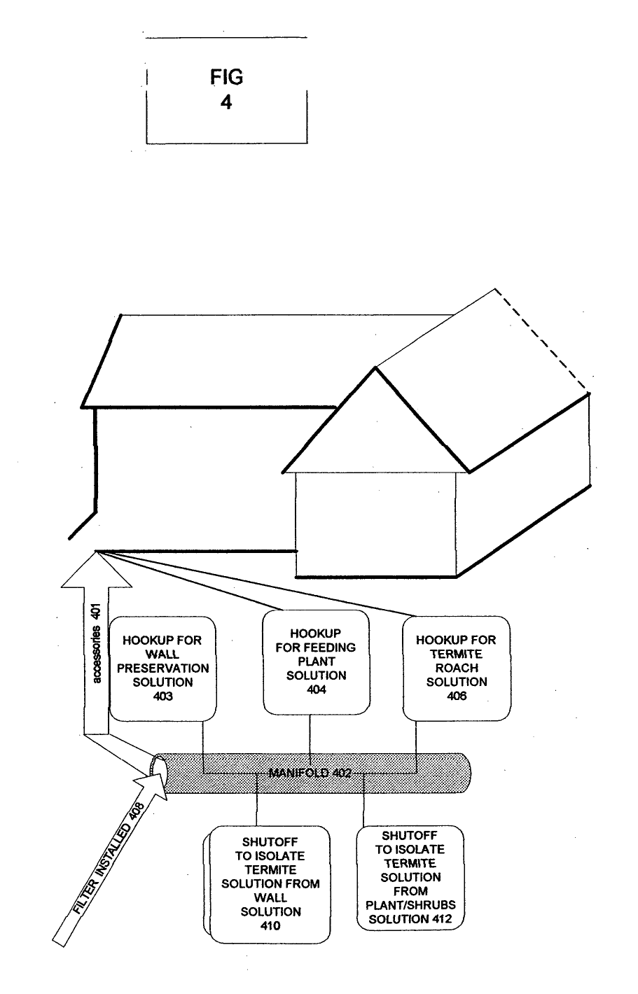

Accessories 401 can be coupled to the piping system. FIG. 4 is a perspective view of FIG. 3 with an added component known as a manifold 402. The manifold can be utilized to allow the system to function for other purposes besides a fire protection system. FIG. 4 shows other containers that can be coupled into the manifold in accordance with an embodiment. For example, a wall preservation solution 402, a nutritious plant solution or fertilizer 404, or a termite/insect repellant or pesticide 406 may be coupled into the manifold. The wall preservative solution can be applied to a surface. A nutritious plant solution can be applied to surrounding shrubbery. A termite/insect repellent can be applied to the lower section of the structure.

An installed filter 408 filters the transport medium in a coupled supply. In an embodiment, a shutoff valve 410 isolates the termite solution from the wall solution, for example. Similarly, a shutoff valve 412 isolates the termite solution from the plant/shrub solution.

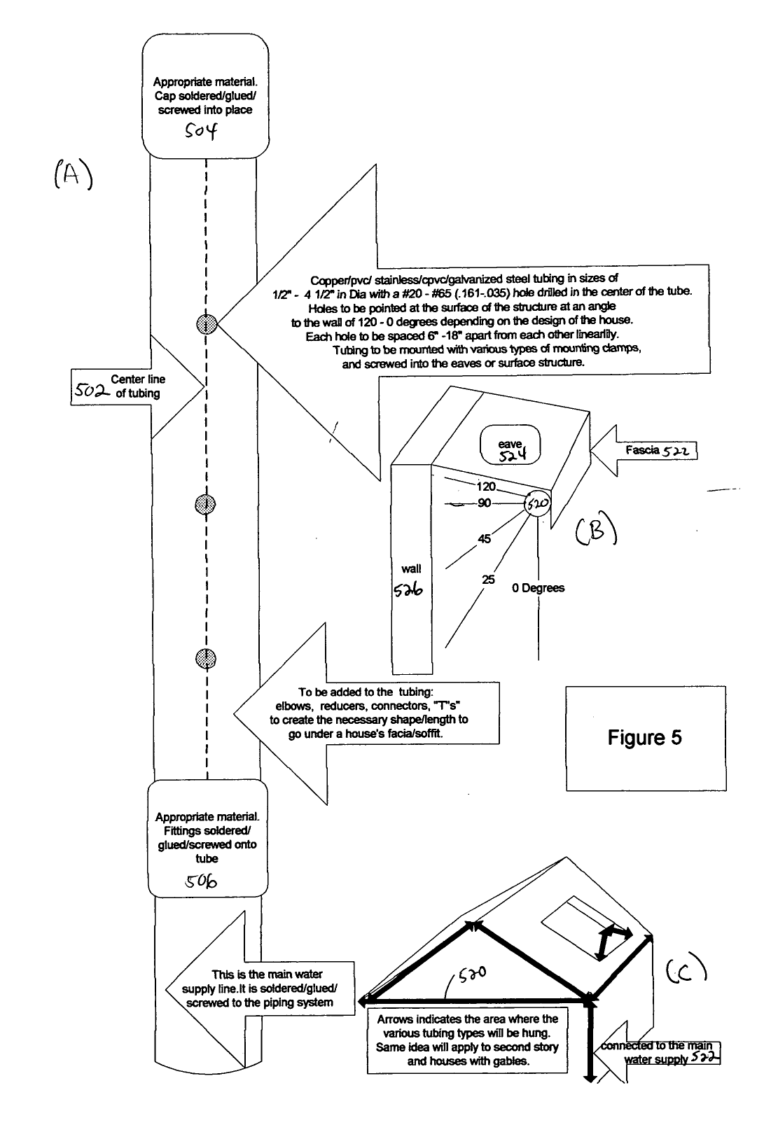

FIG. 5A shows a magnified view of the piping/tubing in accordance with an embodiment. FIG. 5A includes a view of the linearity of the holes in the piping/tubing as shown by a center line of the piping/tubing 502. At the ends of the piping/tubing 504, 506, appropriate material helps screw the piping/tubing 502 into place.

In an exemplary embodiment, copper/pvc/stainless/cpvc/galvanized steel tubing in sizes of ½ inch to 4½ inches in diameter include #20 to #65 (0.161-0.035) holes drilled in the center of the piping/tubing. It would be apparent to those skilled in the art that the hole diameters are based on the application, i.e., purpose of the piping system.

In an embodiment, elbows, reducers, connectors, “T's” can be added to the piping/tubing to create a desired shape/length to go under a house's fascia/soffit, for example. In an embodiment, a main supply line can be soldered, glued, or screwed to the piping system.

FIG. 5B illustrates various angles (0-120 degrees) that the plurality of holes can have with respect to the face of a structure in accordance with an embodiment. The angle is measured with respect to the ground. The piping 520 can be coupled to a fascia 522, which is coupled to an eave 524, which is coupled to a wall 526, the wall 526 being the structure to be protected.

FIG. 5C shows piping 520 with arrows indicating the area where various tubing types are hung in accordance with an embodiment. The same pattern of piping can apply to a second story or houses with gables. Piping 522 is coupled to a main water supply.

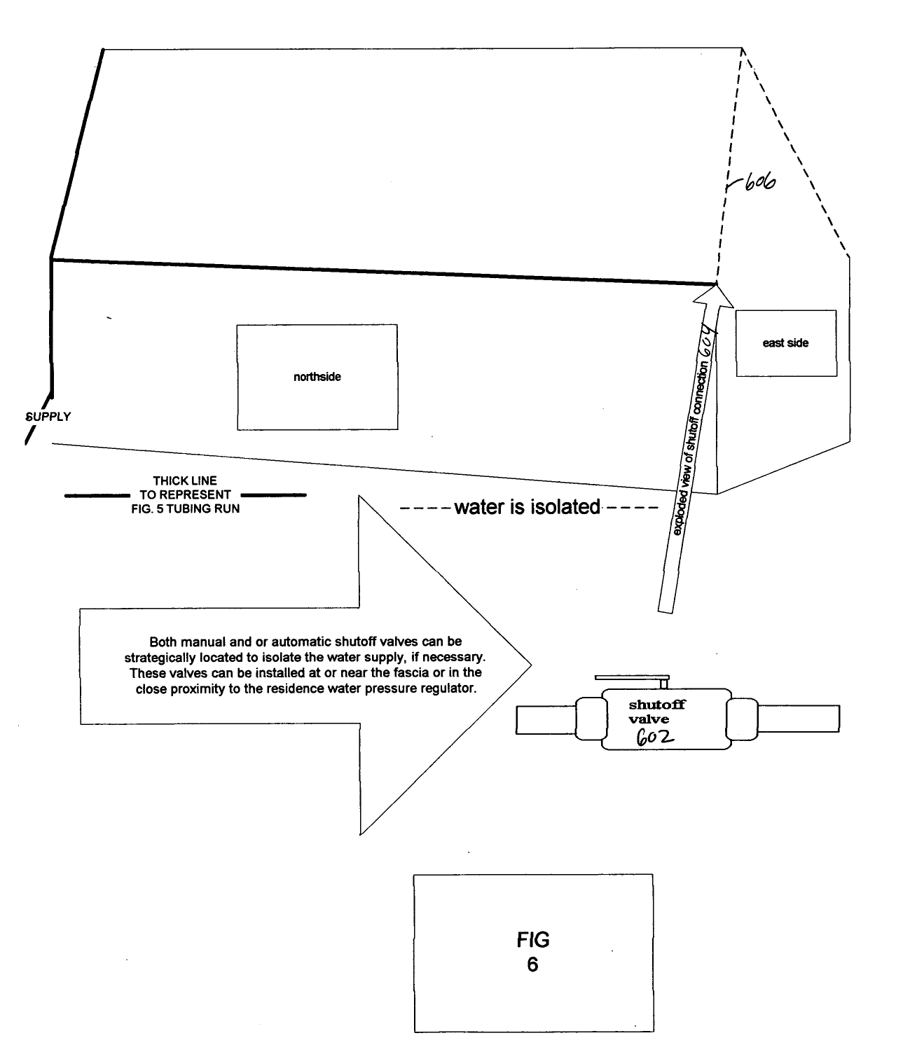

FIG. 6 shows a perspective view of how a liquid/gaseous solution can be isolated within the piping system when applied to a residence in accordance with an embodiment. As shown, an automatic shut off or manual valve 602 is used. A shutoff valve can be used at point 604, for example, thereby shutting off water from piping/tubing 606.

Both manual and automatic shutoff valves can be strategically located to isolate a water supply, for example, if necessary. These valves can be installed at or near the fascia or in the close proximity to a residence water pressure regulator.

This isolation allows the solution to be utilized in a region (i.e., north or south side) where it is needed. In an embodiment, this piping system can also be attached to a gasoline station over-head for the purposes of extinguishing various types of fires.

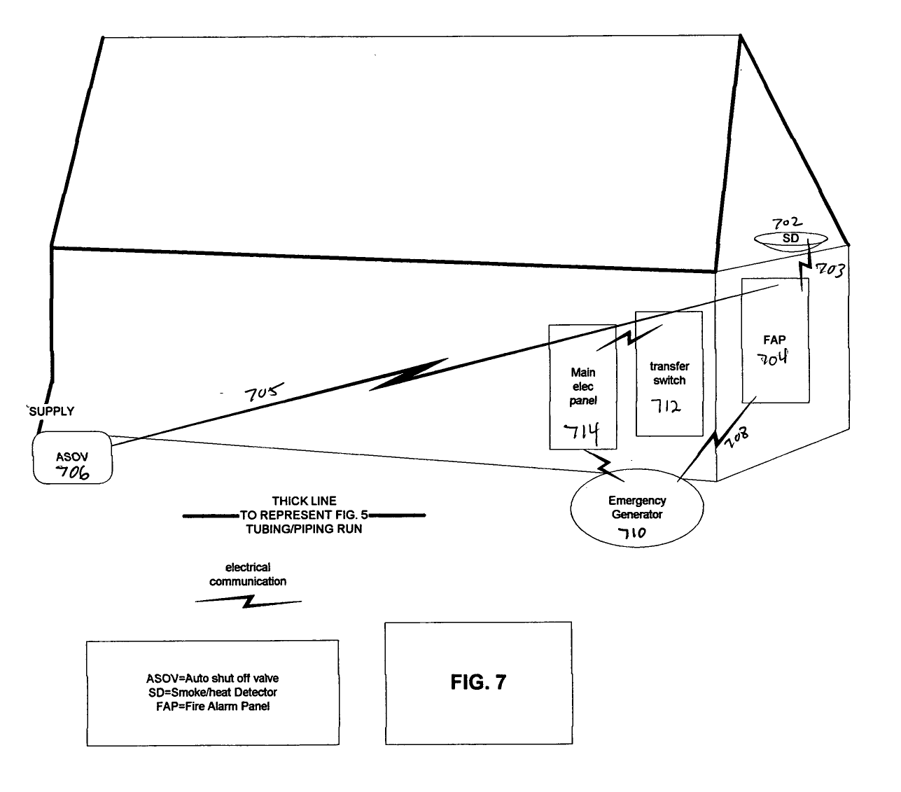

FIG. 7 is a perspective view of how the system can communicate both electrically/electronically with individual components in accordance with an embodiment. FIG. 7 illustrates the smoke/heat detector (SD) 702 detects smoke/heat and transmits a signal 703 indicating detection information to a fire alarm panel (FAP) 704. A notification relay (not shown) in the fire alarm panel can then send a signal 705 to an automatic shut-off valve (ASOV) 706 telling it to open since there is a smoke/fire condition, to allow the flow of a liquid/gaseous solution into the piping from a supply.

The FAP can also send a signal 708 to start an emergency generator 710, to provide auxiliary electrical power if a transfer switch 712 senses a loss in power to a main electrical power panel 714.

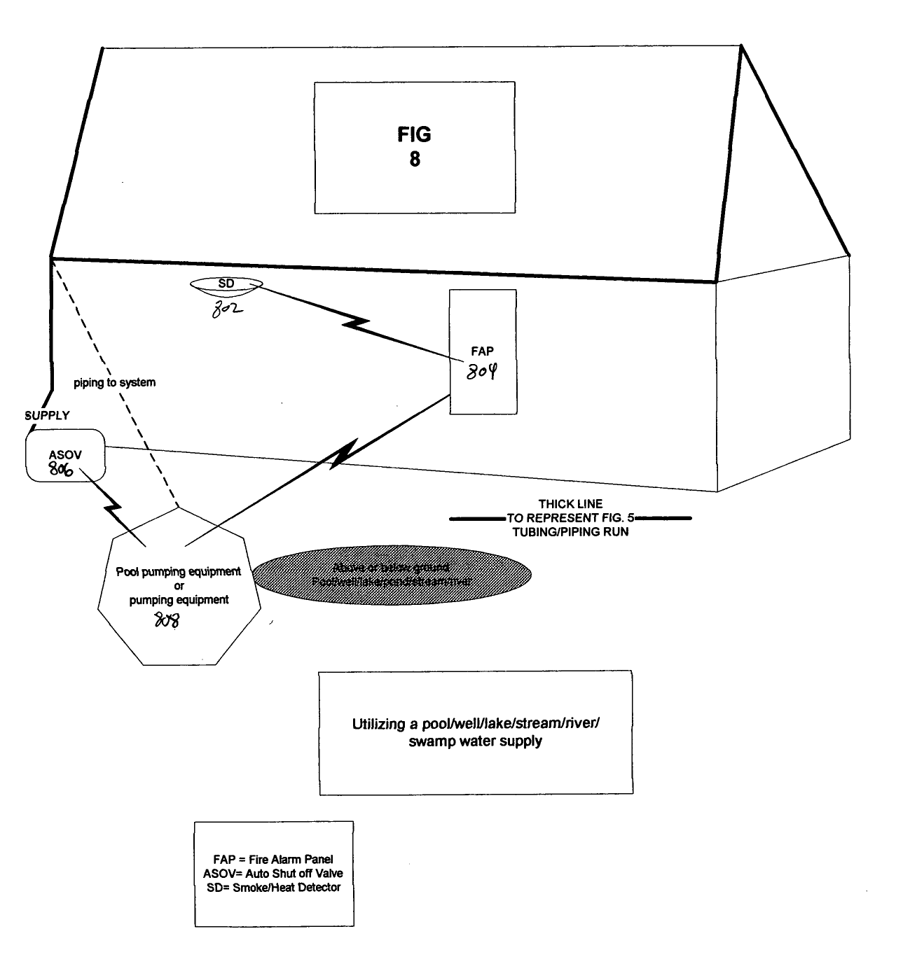

FIG. 8 is a perspective view of the system that is coupled to a supply such as a residence pool, well, stream, river, lake, or swamp in accordance with an embodiment.

FIG. 8 also illustrates how the system can communicate both electrically and electronically with individual components like a smoke/heat detector 802, fire alarm panel 804, and an automatic shut-off valve 806. Also illustrated in FIG. 8 is how an existing pool pumping system 808 can be coupled to the piping system. With the piping system being coupled to a pumping system, the supply can be above or below ground.

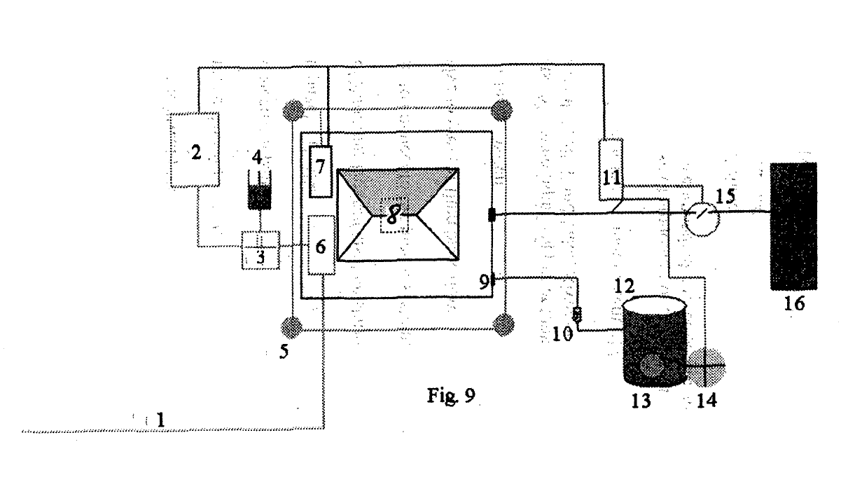

FIG. 9 shows an electromechanical schematic of the system in accordance with an embodiment. Town/city/state/local electrical power is coupled to the residence 1 and goes into the main electrical panel 6. The power is sensed by an electrical transfer switch 3. If power is absent from the grid and the transfer switch senses the loss, the transfer switch moves to the emergency generator 2 side.

The smoke/heat detectors sense the fire danger and send a signal to the fire alarm panel which in turn, sends a signal through an notification alarm circuit to a pressure sensing switch 11 and then to an automatic shut-off valve 15 telling it to open, to allow a liquid/gaseous flow into the piping system. If after a short period of time the pressure sensing switch 11 in the main line do not retract/extend due to the pressure in the line, a signal will be sent to a motor 14. Should an electrical power loss occur, the fire alarm panel's battery backup system takes effect and allows the system to operate normally. The motor 14 will siphon/pressurize a tank/pool/well/river/stream/swamp or container 12 to deliver fluid into the piping system. Should a container 12 be used, a float 13 will be installed inside the container to sense when the pump has run out of liquid/gaseous supply. After the solution leaves the container, it will pass a check valve 10 which is used to prevent any backflow. The fluid/gas continues through a “T” fitting and into the piping system which sends a stream onto the structure surface.

Component Labels

1 Incoming electrical power to a residence

2 Emergency generator

3 Electrical transfer switch

4 Where the electrical power is routed to

5 Heat or smoke detectors (SD)

6 Residence electrical panel

7 Fire alarm panel (FAP)

8 Residence/Building/House/Gasoline station overhang

9 “T” fittings to couple to the piping system

10 Check valve to prevent fluid back flow

11 Pressure sensing switch

12 Represents: Alternate liquid supply or tank with fire retardant solution/Pool/Well/Pond/Lake/River or stream.

13 Float device for shutting off motor, item#14

14 Motor for the purpose of siphoning or pressurizing fluid into or out of the tank/pool/well/pond/lake/river or stream.

15 Automatic or manual shutoff valve (ASOV). When two or more are used in parallel, you can isolate where the fluid will flow.

16 Main liquid supply (water supply)

Those of skill would appreciate that the various illustrative logical blocks, modules, and algorithm steps described in connection with the embodiments disclosed herein may be implemented in varying ways without departing from the scope of the invention. Skilled artisans may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A transport system comprising:
a tubing with substantially equally spaced holes operable to transport a transport medium; and
a supply of a transport medium.

2. A tubing comprising holes substantially equally spaced from each other, the tubing operable to transport a transport medium.

3. The tubing of claim 2, wherein the holes are substantially circular.
